(19) United States
(12) Patent Application Publication
(10) Pub. No.: US 2001/0031166 A1
(43) Pub. Date: Oct. 18, 2001

(54) Carriage guide shaft for printer

(76) Inventor: Hiroya Kobayakawa, Kyoto (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/810,235

(22) Filed: Mar. 16, 2001

(30) Foreign Application Priority Data
Mar. 28, 2000 (JP) 2000/089045

(51) Int. Cl. B41J 19/00

(52) U.S. Cl. 400/283

(57) ABSTRACT

A carriage guide shaft for guiding a carriage of a printer, includes: a carriage guide shaft main body, the circumferential surface thereof having a circumferential surface portion in a range for guiding the carriage, and a low frictional film including a low frictional solid lubricant and formed on at least the circumferential surface portion of the carriage guide shaft main body.

### BACKGROUND OF THE INVENTION

1. Field of the Invention

The present invention relates to a carriage guide shaft for guiding a carriage of a printer, and particularly to a carriage guide shaft having a circumference surface coated with a low frictional film containing a low frictional solid lubricant.

2. Description of the Related Art

In a printer such as an ink jet printer having a carriage provided with a print head, there is provided a carriage guide shaft for guiding and supporting the carriage. The carriage guide shaft is slidably inserted into a guide hole formed in a metal member of the carriage. The carriage makes a reciprocating motion along the guide shaft through the sliding between the guide shaft and the guide hole. The roughness and frictional characteristic of the circumferential surface of the guide shaft has a significant influence on the performance of the printer.

The conventional carriage guide shaft is made of a steel shaft member plated with nickel. The carriage guide shaft is produced as follows. As shown in FIG. 7, a steel shaft member is produced by machining and the shaft member is subjected to straight curing and polished by centerless treatment. Then, the shaft member is polished to have a mirror surface by burnishing or buffing. Then, the shaft member is plated with nickel for the double purpose of rust prevention and improvement of abrasion resistance. Then, the shaft member is baked so that hydrogen is removed from the plating film to thereby make hardness high. In the conventional art, such a printer was shipped in the condition that lubricating oil or grease was applied on the carriage guide shaft in the stage of assembling of the printer.

It was necessary to make the hardness of the circumferential surface of the carriage guide shaft high because the guide hole of the conventional printer was formed of a metal member. Therefore, the carriage guide shaft was plated with nickel for the double purpose of rust prevention and improvement of abrasion resistance. In the case of using such a nickel plating film, however, there was a limit in reduction of the friction coefficient of the carriage guide shaft. Hence, it was difficult to reduce the sliding resistance of the carriage sufficiently to cope with the high speed of the printing.

Moreover, the carriage guide shaft must be mirror-polished by burnishing or buffing after centerless treatment when the carriage guide shaft was produced. Hence, the cost required for polishing was high. It was impossible to omit the nickel plating film because the nickel plating film was essential for the double purpose of rust prevention and retention of abrasion resistance. Particularly in the conventional printer, the printer casing, cover, or the like, made of synthetic resin might be stained with lubricating oil or grease when the lubricating oil or grease was applied onto the carriage guide shaft in the stage of assembling of the printer in the factory. Hence, there was also a problem that the printer became defective because the color of the synthetic resin casing or cover was changed when it was stained with lubricating oil or grease.

Recently, there has been a proposal to make the circumferential surface of the guide hole from a synthetic resin member in order to attain reduction in weight of the carriage. In this case, there is a possibility that specifications required of the surface hardness of the carriage guide shaft may be relaxed.

### SUMMARY OF THE INVENTION

An object of the present invention is to provide a carriage guide shaft in which the friction characteristic of the surface thereof can be made low and in which the cost of production can be reduced.

In a carriage guide shaft for guiding a carriage of a printer according to the invention, a low frictional film containing a low frictional solid lubricant is formed on a circumferential surface portion which is contained in the circumferential surface of the carriage guide shaft and which is in a region for guiding the carriage.

As the low frictional solid lubricant, it is possible to use a coating composition mainly containing a fluororesin, a coating composition mainly containing a fluororesin and molybdenum disulfide, a coating composition mainly containing another low frictional synthetic resin, or the like. The low frictional film can be formed by application of the coating composition mainly containing such a low frictional solid lubricant. Alternatively, the low frictional film can be formed by electrostatic application of powder of the coating composition mainly containing such a low frictional solid lubricant. Incidentally, the low frictional film may be formed over the whole length of the carriage guide shaft.

When the carriage makes a reciprocating motion while slid with respect to the carriage guide shaft and guided by the carriage guide shaft in the case where printing is made by the printer, frictional sliding resistance between the carriage and the carriage guide shaft is reduced on the basis of the lubricating function of the low frictional film containing the low frictional solid lubricant. Hence, high-speed printing can be made.

Particularly, when the guide hole of the carriage is formed from the synthetic resin member, the durability of the low frictional film can be retained because the low frictional film is hardly worn away.

In this carriage guide shaft, the circumferential surface thereof can be formed into a smooth surface near a mirror surface. Hence, it is unnecessary to polish the carriage guide shaft up to a mirror-surface state before the formation of the low frictional film. Hence, the time and cost required for polishing can be reduced. Incidentally, the low frictional film may be formed after a plating film is formed on the carriage guide shaft in order to keep a portion out of the carriage moving range free of rust. Incidentally, when the low frictional film is formed on the whole circumferential surface of the carriage guide shaft, such plating film can be omitted.

### BRIEF DESCRIPTION OF THE DRAWINGS

FIG. 1 is a perspective view of a printer according to an embodiment of the present invention;

FIG. 2 is a side view of a carriage, a carriage guide shaft, and so on;

FIG. 3 is a perspective view of the carriage guide shaft;

FIG. 4 is an enlarged sectional view of important part showing the low frictional film of the carriage guide shaft;

FIG. 5 is a flow chart showing a method for producing the carriage guide shaft;

FIG. 6 is a flow chart showing a modification of the above-mentioned producing method; and

FIG. 7 is a view of a conventional carriage guide shaft corresponding to FIG. 5.

### DETAILED DESCRIPTION OF THE PREFERRED EMBODIMENTS

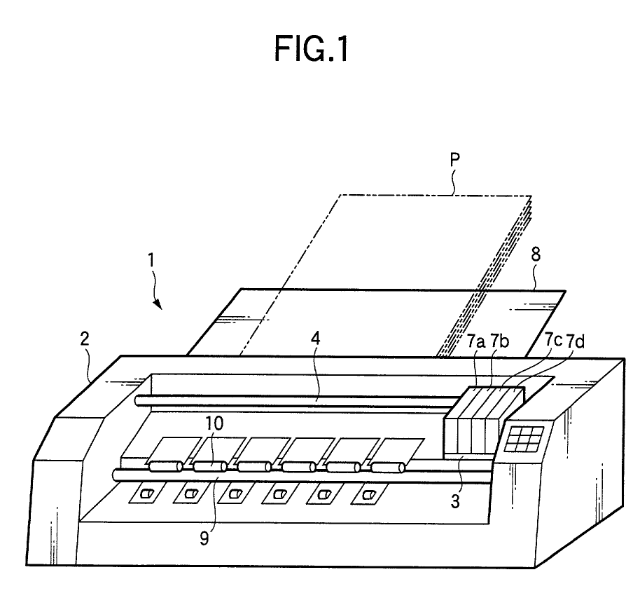

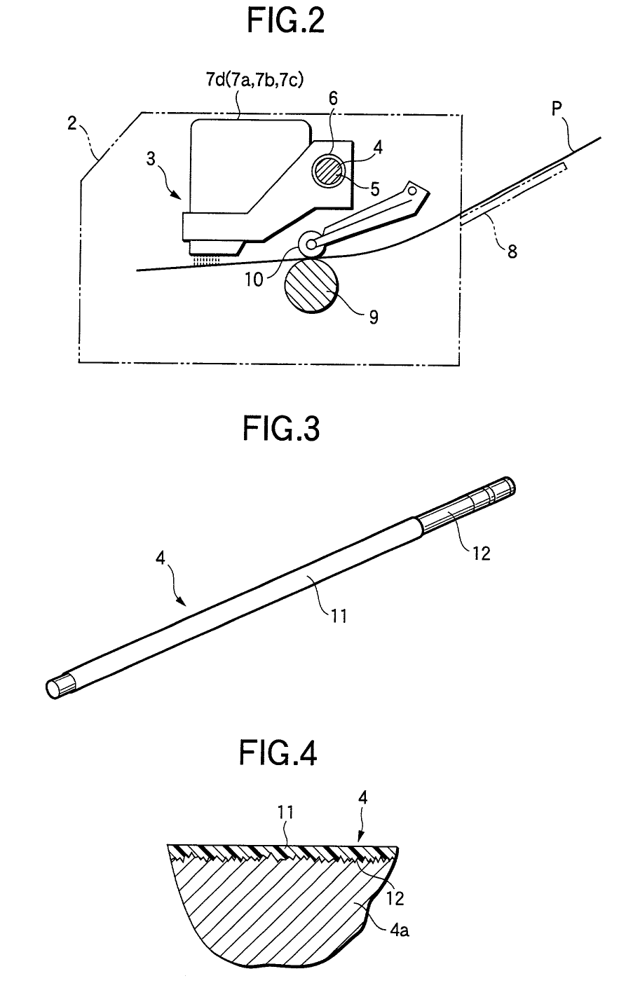

An embodiment of the present invention will be described below with reference to the drawings. As shown in FIGS. 1 and 2, the printer 1 is an ink jet printer. A space for movement of a carriage 3 is provided in an upper surface side portion of a body casing 2. The carriage 3 is guided and supported by a carriage guide shaft 4 so that the carriage 3 can make a reciprocating motion laterally. The movement of the carriage 3 is driven by a stepping motor through a pair of pulleys and a timing belt having opposite ends connected to the carriage 3. A guide hole 5 is provided in the carriage 3 so that the carriage guide shaft 4 is inserted in the hold 5. The guide hole 5 is constituted by a pipe 6 made of a low frictional synthetic resin (such as trade name, Teflon) excellent in abrasion resistance. For example, four-color ink cassettes 7a to 7d are detachably attached to the carriage 3.

A sheet of paper P provided from a tray 8 is fed by a combination of a paper feed roller 9 and a pressing roller 10. Printing is performed on the sheet of paper by the print head of the carriage 3, which reciprocate with respect to the paper P. As shown in FIG. 3, the carriage guide shaft 4 is constituted by a steel shaft member 4a with an outer diameter of from about 8 to about 10 mm. A low frictional film 11 containing a low frictional solid lubricant is formed on a circumferential surface portion at least in a range of the carriage guide shaft 4 for guiding the carriage 3. Incidentally, as shown in FIG. 4, a nickel-plating film 12 is formed on the whole surface of the steel shaft member 4a constituting the carriage guide shaft 4, and the low frictional film 11 is formed on the nickel-plating film 12.

The low frictional film 11 is a film mainly containing a solid lubricant mainly composed of a combination of a fluororesin (such as trade name Teflon), molybdenum disulfide, etc. The low frictional film 11 has a thickness (for example, in a range of from 5 to 120 μm) of not smaller than the surface roughness of the shaft member 4a before the formation of the low frictional film. The low frictional film 11 can be formed by application of a commercially available lubricating coating composition mainly containing the aforementioned solid lubricant made of a combination of a fluororesin, molybdenum disulfide, etc. Incidentally, the low frictional film 11 may be a film mainly containing a solid lubricant of a fluororesin (for example, trade name Teflon) without containing molybdenum disulfide or may be a film mainly containing another solid lubricant.

When the aforementioned lubricating coating composition is sprayed and dried to thereby form the low frictional film 11, it is preferable to form the low frictional film 11 to have a thickness in a range of from about 10 to about 20 μm. Incidentally, the low frictional film 11 may be also formed by electrostatic coating and baking of powder mainly containing the aforementioned solid lubricant. In this case, it is preferable to form the low frictional film 11 to have a thickness in a range of from about 80 to about 120 μm because it is difficult to make the low frictional film 11 thinner.

Next, a method for producing the carriage guide shaft 4 will be described below.

As shown in FIG. 5, a steel rod material is first machined to produce a shaft member 4a with the same size as that of the carriage guide shaft 4. The shaft member 4a is subjected to straight curing. Then, the circumferential surface of the shaft member 4a is polished by centerless treatment. The surface roughness Ry (maximum roughness) of the circumferential surface-of the shaft member 4a after the centerless treatment is in a range of from about 2.5 to about 3.0 μm.

Then, the shaft member 4a is plated with nickel so that a nickel-plating film 12 (for example, with a thickness in a range of from about 3 to 5 μm) is formed on the whole surface of the shaft member 4a. The plating film 12 is provided so that a portion not coated with the low frictional film 11 is kept free of rust.

Then, while the shaft member 4a is rotated, a coating composition is sprayed onto the circumferential surface portion which is in a carriage-moving range (a range for guiding the carriage 3) in the circumferential surface of the shaft member 4a. Thus, a low frictional film 11 having a thickness in a range of from about 10 to about 20 μm is formed. In this case, a commercially available lubricating coating composition mainly containing a solid lubricant composed of a combination of a fluororesin (such as trade name Teflon) and molybdenum disulfide, which serves as the coating composition is diluted with a paint thinner. The diluted coating composition is sprayed by a spray gun under spray pressure in a range of from 0.3 to 0.4 MPa. Then, the shaft member 4a thus coated is put into a dry furnace and dried in the condition in a range of from about 180 to about 200° C. for about 20 minutes. Incidentally, molybdenum disulfide as a low frictional solid lubricant contained in the coating composition is not always essential and may be omitted.

In the carriage guide shaft 4 produced in the aforementioned manner, the black low frictional film 11 (having a thickness in a range of from about 10 to about 20 μm) mainly containing a low frictional solid lubricant composed of a combination of a fluororesin and molybdenum disulfide is formed on the circumferential surface portion of the carriage guide shaft 4 which is in the range for guiding the carriage 3. The friction coefficient of the carriage guide shaft 4 is about 0.8 times as high as that (about 0.50) of the conventional carriage guide shaft plated with nickel. That is, the frictional sliding resistance of the carriage guide shaft 4 can be reduced by about 20%. Accordingly, the friction coefficient between the carriage and the carriage guide shaft is substantially 0.40 or less. Preferably, the friction coefficient therebetween is substantially 0.25 or less, and more preferably, the friction coefficient is substantially 0.13 or less.

Moreover, the region in which the low frictional film 11 is formed is kept free of rust doubly by the plating film 12 and the low frictional film 11 because the low frictional film 11 also has an antirust function. Moreover, the surface of a portion which is of the carriage guide shaft 4 and which is not coated with the low frictional film 11 is protected by the nickel-plating film 12 so as to be kept free of rust.

Moreover, burnishing or buffing for mirror-polishing the carriage guide shaft may be omitted when the carriage guide shaft is produced. Hence, the time and cost required for polishing can be reduced greatly. When the carriage 3 side guide hole is formed by a member made of a synthetic resin (such as a fluororesin type synthetic resin, or the like), specifications required of the surface hardness of the carriage guide shaft 4 are relaxed so that sufficient durability against friction can be retained even in the case where the carriage guide shaft 4 is coated with the low frictional film 11.

Partial modifications of the aforementioned embodiment will be described below.

1) Although the aforementioned embodiment of the method for producing the carriage guide shaft has been described upon the case where the carriage guide shaft 4 is plated with nickel, the whole circumferential surface of the carriage guide shaft 4 may be coated with the low frictional film 11. In this case, nickel plating can be omitted because the whole surface of the carriage guide shaft 4 can be kept free of rust by the low frictional film 11. Accordingly, the cost of production of the carriage guide shaft 4 can be reduced more greatly.

2) Although the aforementioned embodiment of the method for producing the carriage guide shaft 4 has been described upon the case where the low frictional film 11 is formed on the carriage guide shaft 4 by spray coating, the low frictional film 11 may be formed by electrostatic coating (electrostatic powder coating). The method for producing the carriage guide shaft 4 in this case will be described below.

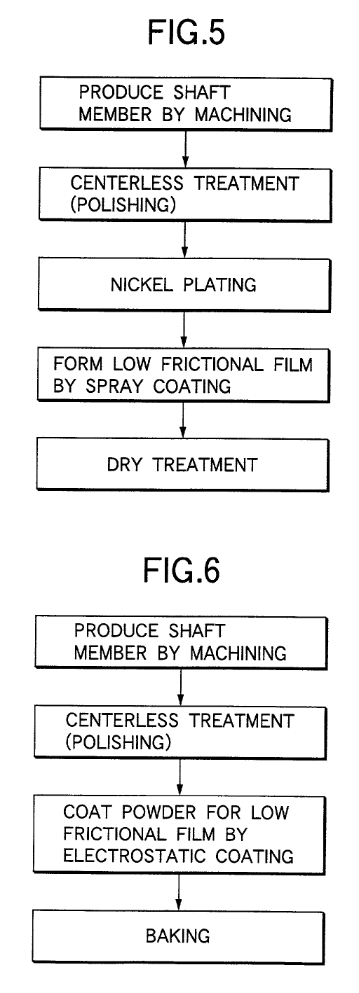

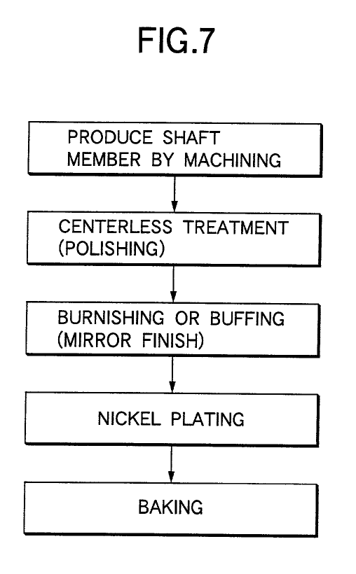

As shown in FIG. 6, a shaft member 4a is produced by machining in the same manner as described above. Then, after the shaft member 4a is subjected to straight curing and centerless treatment, it is subjected to electrostatic coating.

In this case, powder of a lubricating coating composition mainly containing a solid lubricant composed of a combination of a fluororesin (such as trade name Teflon) and molybdenum disulfide is used as powder for forming the low frictional film. In the condition that the shaft member 4a is electrically connected to the ground while rotated, the coating composition powder electrified to a high plus potential is sprayed from a spray gun so as to be deposited by a predetermined thickness on the whole surface of the shaft member 4a. Then, the shaft member 4a is put in a high-frequency heating furnace or the like and baked at about 180° C. for about 20 minutes, whereby a carriage guide shaft 4 is obtained.

The low frictional film formed on the carriage guide shaft 4 by the electrostatic coating is a low frictional film mainly containing a low frictional solid lubricant and having a thickness in a range of from about 80 to about 120 μm. According to the method for producing the carriage guide shaft 4, nickel plating can be omitted because the low frictional film is formed on the whole surface of the shaft member 4a. Incidentally, the low frictional film may be formed only on the circumferential surface portion of the carriage guide shaft 4 which is in a range for guiding the carriage 3. In this case, nickel plating is applied before the electrostatic coating.

According to the invention, sliding friction between the carriage and the carriage guide shaft is made low by the lubricating function of a low frictional film containing a low frictional solid lubricant. Hence, high-speed printing can be performed. Particularly, when the circumferential surface of the guide hole of the carriage is formed of a synthetic resin member, the low frictional film is hardly worn away. Hence, the durability of the low frictional film can be kept sufficiently. Moreover, lubricating oil or grease need not be applied on the carriage guide shaft in the factory. Hence, there is no risk that the printer casing or cover may be stained with such lubricating oil or grease when the lubricating oil or grease is applied on the carriage guide shaft.

Moreover, the circumferential surface can be formed as a smooth surface by the low frictional film. Hence, it is not necessary to polish the shaft member up to a mirror-surface state in polishing before the formation of the low frictional film. Hence, the cost required for polishing can be reduced. Incidentally, when the low frictional film is formed on the whole ciecumferential surface of the carriage guide shaft, the coat of production can be reduced more greatly because the plating film can be also omitted.

In addition, since the low frictional film is a film mainly containing a fluororesin, the low frictional film can be formed easily by application of a commercially available coating composition mainly containing a fluororesin (such as trade name Teflon).

Further, since the low frictional film is a film mainly containing a fluororesin and molybdenum disulfide, the low frictional film can be formed easily by application of a commercially available coating composition mainly containing a fluororesin (such as trade name Teflon) and molybdenum disulfide.

Moreover, since the low frictional film has a thickness not smaller than the surface roughness of the shaft member before the formation of the low frictional film, the whole surface of the circumferential surface portion of the carriage guide shaft which is at least in the carriage moving range can be covered with the low frictional film. Hence, the member for forming the carriage side guide hole is hardly worn away, so that durability can be retained.

Additionally, since the low frictional film has a thickness in a range of from 5 to 120 μm, the thickness of the low frictional film is not smaller than the surface roughness of the shaft member before the formation of the low frictional film. Hence, the portion which is contained in the circumferential surface of the carriage guide shaft and which is provided for forming the low frictional film can be covered with the low frictional film. Hence, the member for forming the carriage side guide hole is hardly worn away, so that durability can be retained.

While only certain embodiments of the invention have been specifically described herein, it will apparent that numerous modifications may be made thereto without departing from the spirit and scope of the invention.

What is claimed is:

1. A carriage guide shaft for guiding a carriage of a printer, comprising:
a carriage guide shaft main body, the circumferential surface thereof having a circumferential surface portion in a range for guiding the carriage; and
a low frictional film including a low frictional solid lubricant and formed on at least the circumferential surface portion of the carriage guide shaft main body.

2. The carriage guide shaft according to claim 1, wherein the low frictional solid lubricant comprises a fluororesin.

3. The carriage guide shaft according to claim 2, wherein the low frictional solid lubricant further comprises a molybdenum disulfide.

4. The carriage guide shaft according to claim 1, wherein the low frictional film has a thickness more than a surface roughness of the carriage guide shaft main body before the formation of the low frictional film.

5. The carriage guide shaft according to claim 1, wherein the low frictional film has the thickness of substantially 5-120 μm.

6. The carriage guide shaft according to claim 1, produced by a process comprising the steps of:
forming the low frictional film by spray coating a lubricant coating composition comprising the low frictional solid lubricant on the carriage guide shaft main body; and
drying the carriage guide shaft main body coated with the low frictional film.

7. The carriage guide shaft according to claim 1, produced by a process comprising the steps of:
forming the low frictional film by electrostatically coating a lubricant coating powder comprising the low frictional solid lubricant on the carriage guide shaft main body; and
baking the carriage guide shaft main body coated with the low frictional film.

8. The carriage guide shaft according to claim 1, wherein the carriage guide shaft is slidably guided on the carriage by passing through a guide hole formed in the carriage, the surface of the guide hole is made of a synthetic resin, and
wherein the friction coefficient between the carriage and the carriage guide shaft is substantially 0.40 or less.

9. The carriage guide shaft according to claim 8, wherein the carriage guide shaft is substantially 0.25 or less.

10. The carriage guide shaft according to claim 9, wherein the carriage guide shaft is substantially 0.13 or less.
